(19) United States
(12) Patent Application Publication
(10) Pub. No.: US 2016/0245486 A1
(43) Pub. Date: Aug. 25, 2016

(54) HIGH INTENSITY MODULAR LIGHT FIXTURES

(71) Applicant: 3M INNOVATIVE PROPERTIES COMPANY, Saint Paul, MN (US)

(72) Inventors: David G. Freier, St. Paul, MN (US); Michael A. Meis, Stillwater, MN (US); Thomas R. Hoffend, Jr., Woodbury, MN (US); Anthony J. Piekarczyk, Inver Grove Heights, MN (US); Scott E. Simons, Forest Lake, MN (US); Matthew M. Philippi, St. Paul, MN (US); Kenneth A. P. Meyer, White Bear Township, MN (US)

(21) Appl. No.: 15/026,469

(22) PCT Filed: Oct. 15, 2014
(86) PCT No.: PCT/US14/60626

§ 371 Date: Mar. 31, 2016

Related U.S. Application Data
(60) Provisional application No. 61/895,677, filed on Oct. 25, 2013.

(51) Int. Cl. F21V 13/04; F21S 8/04; F21V 29/70; F21S 8/08

(52) U.S. Cl. CPC F21V 13/04; F21S 8/08; F21S 8/04; F21V 29/70; F21Y 2101/02

(57) ABSTRACT

The present disclosure describes advanced lighting elements, in particular solid-state lighting elements, and luminaires that include an array of lighting elements. The lighting elements, and luminaires including the lighting elements can exhibit benefits that include high optical efficiency and therefore high luminous efficacy; extraordinary directional control and therefore extraordinary glare control and efficacy of delivered lumens; and exceptional mixing of individual-device emission providing exceptional suppression of punch-through and color breakup. In many cases, the architecture can be amenable to low-cost manufacturing in a modular format.

### BACKGROUND

Linear lighting and point lighting are two common strategies used to create uniform illumination of large areas. In linear lighting, linear luminaires are disposed along parallel lines, generally at a constant pitch. The illumination from any one luminaire is usually non-uniform, extending over a segment of the target surface that is considerably wider than the luminaire pitch, yet in a manner such that the combined illumination from all of the luminaires is relatively uniform. In point lighting, point luminaires are disposed on a regular two-dimensional grid. The illumination from one luminaire can be non-uniform, extending over an area larger than the unit cell of the luminaire grid, yet the combined illumination of all luminaires is relatively uniform. In both strategies, multiple luminaires can contribute to the illumination at any point, facilitating the suppression of shadows.

### SUMMARY

The present disclosure describes advanced lighting elements, in particular solid-state lighting elements, and luminaires that include an array of lighting elements. The lighting elements, and luminaires including the lighting elements can exhibit benefits that include high optical efficiency and therefore high luminous efficacy; extraordinary directional control and therefore extraordinary glare control and efficacy of delivered lumens; and exceptional mixing of individual-device emission providing exceptional suppression of punch-through and color breakup. In many cases, the architecture can be amenable to low-cost manufacturing in a modular format. In one aspect, the present disclosure provides a lighting element that includes a light collimating horn having an input end, an output end, and horn sidewalls connecting the input end to the output end; a light source having an emitting surface disposed within the input end; and a redistribution plate disposed adjacent the output end of the light collimating horn, the redistribution plate having a structured refraction surface facing the input end. The redistribution plate is capable of reshaping a partially-collimated angular distribution of incident luminance from the light source to match a prescribed angular distribution of transmitted luminance.

In another aspect, the present disclosure provides a luminaire that includes an array of lighting elements, each lighting element having a light collimating horn having an input end, an output end, and horn sidewalls connecting the input end to the output end; a light source having an emitting surface disposed within the input end; and a redistribution plate disposed adjacent the output end of the light collimating horn, the redistribution plate having a structured refraction surface facing the input end. The redistribution plate is capable of reshaping a partially-collimated angular distribution of incident luminance from the light source to match a prescribed angular distribution of transmitted luminance.

In yet another aspect, the present disclosure provides a luminaire that includes an array of lighting elements, each lighting element having a light collimating horn having an input end, an output end, horn sidewalls connecting the input end to the output end, and a pointing direction from the input end to the output end; a light source having an emitting surface disposed within the input end; and a redistribution plate disposed adjacent the output end of the light collimating horn, the redistribution plate having a structured refraction surface facing the input end. Each of the array of lighting elements is disposed adjacent a light pole top end extending from a target surface, the pointing directions collectively arranged in a pyramid shape directed toward the target surface, and the redistribution plate is capable of reshaping a partially-collimated angular distribution of incident luminance from the light source to match a prescribed angular distribution of transmitted luminance.

The above summary is not intended to describe each disclosed embodiment or every implementation of the present disclosure. The figures and the detailed description below more particularly exemplify illustrative embodiments.

### BRIEF DESCRIPTION OF THE DRAWINGS

Throughout the specification reference is made to the appended drawings, where like reference numerals designate like elements, and wherein:

FIG. 1A shows a schematic cross-sectional view of a lighting element;

FIG. 1B shows a schematic perspective view of a lighting element;

FIGS. 2A-2E show schematic side views of lighting element orientations;

FIG. 3 shows a schematic cross-sectional view of a linear array luminaire;

FIG. 4 shows a perspective view of a rectangular array luminaire;

FIGS. 5A-5C show schematic side views of luminaire illumination;

FIG. 6 shows a tilted perspective view of a luminaire; and

FIG. 7 shows an SEM image of a redistribution plate surface.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

The present disclosure provides for advanced lighting elements, in particular solid-state lighting elements, and luminaires that include an array of lighting elements. The lighting element, and luminaires including the lighting elements can exhibit benefits that include high optical efficiency and therefore high luminous efficacy, extraordinary directional control and therefore extraordinary glare control and efficacy of delivered lumens, and exceptional mixing of individual-device emission providing exceptional suppression of punch-through and color breakup. In many cases, the architecture can be amenable to low-cost manufacturing in a modular format.

Applications of the lighting elements and luminaires to large-area point lighting are not limited to indoor commercial spaces. Ruggedized versions may prove to be beneficial in point lighting of roadways, parking lots, parking garages, and/or roadway tunnels. Generally, in addition to the high optical efficiency, high luminous efficacy, and adequate mixing of individual-device emissions from existing devices, the present invention also provides an advantage in directional control, providing for glare reduction, and an ability to meet illumination specifications without localized over-illumination—i.e., high efficacy of delivered lumens.

In the following description, reference is made to the accompanying drawings that forms a part hereof and in which are shown by way of illustration. It is to be understood that other embodiments are contemplated and may be made without departing from the scope or spirit of the present disclosure. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

As used herein, when an element, component or layer for example is described as forming a “coincident interface” with, or being “on” “connected to,” “coupled with” or “in contact with” another element, component or layer, it can be directly on, directly connected to, directly coupled with, in direct contact with, or intervening elements, components or layers may be on, connected, coupled or in contact with the particular element, component or layer, for example. When an element, component or layer for example is referred to as being “directly on,” “directly connected to,” “directly coupled with,” or “directly in contact with” another element, there are no intervening elements, components or layers for example.

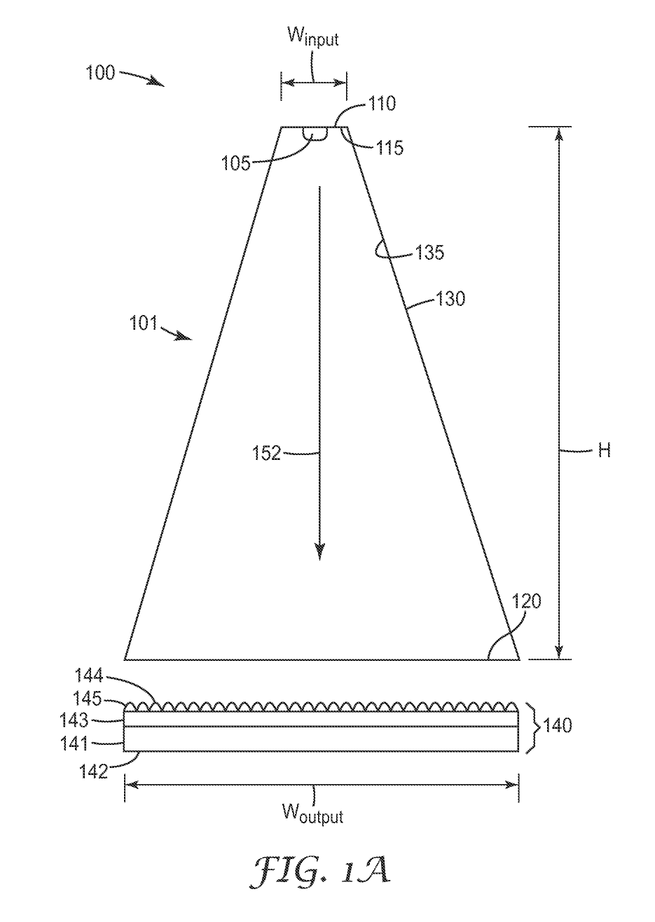

FIG. 1A shows a schematic cross-sectional view of a lighting element 100, according to one aspect of the disclosure. Lighting element 100 includes a light collimating horn 101 having an input end 110, and output end 120, and horn sidewalls 130 connecting the input end 110 to the output end 120. The lighting element 100 further includes a light source 105 disposed within the input end 110 of the light collimating horn 101, and a redistribution plate 140 disposed adjacent the output end 120 of the light collimating horn 101. The light source 105 is disposed to inject light along a pointing direction 152 running from the input end 110 to the output end 120.

The light collimating horn 101 has a height “H” between the input end 110 and the output end 120, and can have any desired cross-sectional shape perpendicular to the pointing direction 152. In some cases, the cross-sectional shape can be a circular shape, an oval shape, a rectangular shape, a square shape, a hexagonal shape, or other polygonal shapes capable of tiling a planar surface, as described elsewhere. In some cases, each dimension of the output end 120 is equal to or greater than a corresponding dimension of the input end 110. In one particular embodiment, as shown throughout the FIGS. and described herein, the cross-sectional shape can be a square shape. It is to be understood that the square shape is not to be in any way limiting, and simply serves as an example for the cross-sectional shape. Generally, the input end 110 and the output end 120 are parallel to each other; however, in some cases, they may not be parallel.

The light collimating horn 101 can be a transparent solid horn that is capable of collimating light by total internal reflection (TIR) or it can be a hollow horn that is capable of collimating light by reflection from specularly reflective interior surface. In one particular embodiment, a hollow horn is preferable, and an interior surface 135 of the light collimating horn 101 is specularly reflective. The specularly reflective interior surface 135 can be any suitable specular reflective surface including, for example, an inorganic interference reflector, an organic interference reflector, a metallic reflector, a metalized polymeric film reflector, or a combination thereof. In one particular embodiment, the specularly reflective interior surface 135 is a polymeric multilayer film such as an Enhanced Specular Reflective (ESR) film available from 3M Company.

The geometry of the light collimating horn 101 serves to partially-collimate light injected from the light source 105, as described elsewhere. The input end 110 has an input width Wᵢₙₚᵤₜ, and includes an input end surface 115 that can be specular reflective surface, a diffuse reflective surface, or a combination thereof. The input end 110 can also include a heat sink (not shown) to extract heat generated by the light source 105. The output end 120 of the light collimating horn 101 has an output width Wₒᵤₜₚᵤₜ, and together with the height “H” and the input end 110 of the light collimating horn 101, a relationship can be derived for the degree of collimation of the input light exiting the output end 120 of the light collimating horn 101. In one particular embodiment, the relationship between the output width Wₒᵤₜₚᵤₜ, the input width Wᵢₙₚᵤₜ, and the height “H” for suitable collimation of light can be given by the expression: |Wᵢₙₚᵤₜ−Wₒᵤₜₚᵤₜ|/H≦¼.

The redistribution plate 140 is disposed adjacent the output end 120 of the light collimating horn 101, and in some cases is disposed immediately adjacent the output end 120, although in some cases, they can be separated by another optical component or an air gap. The redistribution plate includes a polymeric resin 145 having a structured refraction surface 144 facing the input end 110, an optional polymeric film support 143 onto which the polymeric resin 145 is cast, and an optional transparent support plate 141 having an opposing output surface 142, which serves as a structural support for the redistribution plate 140. Each of the structured refraction surface 144 and/or the opposing output surface 142 may include an anti-reflection coating, as known to one of skill in the art. In one particular embodiment, the structured refraction surface 144 includes tapered protrusions. The redistribution plate 140 is capable of reshaping a partially-collimated angular distribution of incident luminance from the light source 105 to match a prescribed angular distribution of transmitted luminance, as described elsewhere.

A redistribution plate generally consists of a microstructured film, comprising an optical substrate and microstructures disposed on one side of the substrate, laminated to a clear plate for structural support, as described elsewhere. In some cases, an antireflective coating can be applied on the side of the plate opposite the microstructured film, on the microstructured surface, or both. Preferably, the antireflective coating is provided on the plate side opposite the microstructured film. Alternately, the steering plate might consist of the same structured surface embossed directly on one side of the plate, with an anti-reflective coating on the other surface. In either case, the structure serves to redirect emission from the horns via refraction upon transmission so as to more closely match a prescribed angular distribution of luminance to be emitted by the luminaire. The assembled redistribution plate can be attached to the array of horns immediately adjacent to and coplanar with the output ends. In the preferred configuration, the structures on the plate face the output ends.

Given the area-averaged angular distribution of luminance exiting the horns, a characteristic index of refraction representative of the steering plate (preferably, all components possess similar indices), and the reflectivity of the AR coat for incidence from within the plate, and given a prescribed angular distribution of transmitted luminance, a distribution of surface normals for the structure is determined by the following technique.

The structure is selected so that when the redistribution plate is illuminated by an angular distribution of incident luminance partially collimated about the normal to the plate, the luminance transmitted through the plate along principal ray paths exhibits the minimum possible average squared deviation from the prescribed angular distribution of transmitted luminance.

Structures satisfying this criterion are determined by expressing the area average transmitted luminance as a known linear transform of the unknown areal density of surface normals. The known transform is evaluated by accounting for refractive redirection along principal ray paths through the redistribution plate. The squared deviation is then a quadratic form in the density of surface normals. The density of normals is determined by minimizing the quadratic form subject to the constraint of non-negative density.

An appropriate structure is then determined by tiling the unit cell of the microstructure with an ensemble of planar facets possessing the optimal density of normals. The ordering of the facets is selected to optimally satisfy additional criteria which account for, for example, the degree to which principal ray paths account for all of the transmission, or the make-ability of the structure. In the simple case of one dimensional structures the preferred ordering is usually that of monotonically decreasing slope between the left and right edges of the unit cell.

In some circumstances non-uniform weighting is used in the average squared deviation. For example, when a prescribed pattern of illuminance is desired on a horizontal surface beneath a horizontal redistribution plate, the average squared deviation in luminance is weighted by the eighth power of the cosine of the angle between the direction of transmission and the normal to the plate so as to uniformly weight the deviations in illuminance.

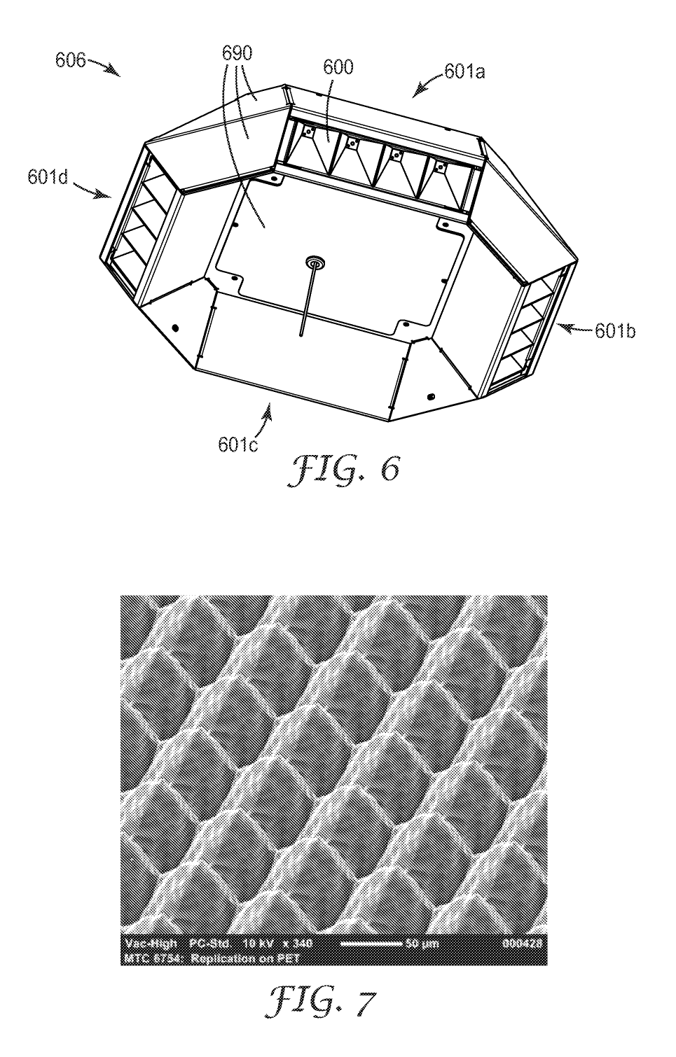

When this distribution of normals is expressed in the structure of the steering plate, and the steering plate is illuminated by the horns, the squared deviation between the luminance emitted by the luminaire and that prescribed attains its minimum possible value. The minimum possible value is the minimum possible squared deviation between the prescribed distribution and that output by single-pass transmission through any single-sided structure illuminated by the input light distribution. FIG. 7 shows an SEM image of a redistribution plate surface, according to one aspect of the disclosure. It can be seen in FIG. 7, that the surface can comprise a series of protrusions having complex surface structures.

The illuminance cast upon any target surface by the luminaire can be evaluated by appropriately weighting and summing the luminance emitted in different directions. When the luminance is so weighted and summed in the deviation, the distribution of surface normals determined by the technique minimizes the squared deviation between the illuminance cast by the luminaire and that prescribed upon the target surface. Thus, structures may be selected to match either a desired distribution of emitted luminance or a desired pattern of cast illuminance. Lighting design often concerns primarily the latter.

The transmissivity of the redistribution plate is high, due to minimization of total internal reflection by the structure-up configuration, the bottom-surface AR coat, and the collimation of incidence about the normal to the plane of the plate. This attribute is in large part responsible for the high optical efficiency of the luminaire. The associated lack of reflection prohibits recycling, which in turn prohibits an increase in collimation upon incorporation of the plate. Therefore, the emission of the luminaire is comparably or less collimated than the emission of the horns. While the plate by design optimally shapes the emission to match that prescribed, close correspondence is achieved when the prescription is comparably of less collimated than the emission of the horns.

Light collimating horns generally refers to a hollow prismoid that includes two similarly-oriented rectangular apertures in disjoint parallel planes, and four trapezoidal faces connecting parallel edges of rectangles in disjoint planes. The interior surface of each trapezoidal face possesses a highly-reflective mirror finish. One aperture is designated the input end, and the other the output end. For collimating horns, each dimension of the outlet exceeds the corresponding dimension of the inlet.

In the usual circumstance, the separation “H” between the center of the input end and the center of the output end is normal to the planes containing these apertures. Then, the geometry of the collimating horn is specified by the dimensions of the input end W_{input, x}×W_{input, y}, (or Wᵢₙₚᵤₜ for a square aperture) those of the output end W_{output, x}×W_{output, y}, (or Wₒᵤₜₚᵤₜ for a square aperture), and the normal separation of the apertures “H”.

When an inwardly light-emitting surface occupies the input end of a sufficiently deep and highly-reflective collimating horn, the luminance exiting the output end will be substantially uniform over the outlet and confined to directions within an elliptic cone of half angles given by:

Ψ_{1/2, x}=arcsin(W_{input, x}/W_{output, x}) and Ψ_{1/2, y}=arcsin(W_{input, y}/W_{output, y})

in the x and y directions, respectively. This luminance is independent of both the spatial and angular distributions of emission on the inlet.

In many cases, LEDs are the preferred source for illuminating collimating horns. The inlet may contain just one device at its center, or as many devices as are necessary to tile the entirety of its surface. In the latter case, since many LEDs are approximate Lambertian emitters, the source emission resembles Lambertian luminance uniformly filling the inlet. Since most LED packages are diffuse reflecting, the emitting surface most-closely resembles a diffuse (as opposed to specular) reflector. Further, since many lighting applications require axially-symmetric emission, we focus on a class of collimating horns for which the ratios of each dimension of the input end to the corresponding dimension of the output end is equal, and can be referred to as ‘circularly collimating’. Finally, without any real loss of generality, we can assume a square horn for which a single width Wᵢₙₚᵤₜ (herein W_{<}), Wₒᵤₜₚᵤₜ (herein W_{>}) can be used to describe the input end and output end, respectively.

The minimum half angle of collimation deliverable by a horn depends upon system requirements pertaining to adequate areal densities of delivered flux and, to a lesser extent, acceptable length. Design experience suggests ψ_{1/2}≈15° as reasonable benchmark limit. Accordingly, restricting use of the disclosed luminaires to applications requiring no tighter than 15-degree collimation is preferred. Fortunately, a vast number of lighting applications are included in this category. The primary exceptions are spot lighting, and narrow and medium-beam flood lighting. In much the same manner as fine detail cannot be painted with a broad brush, one also cannot expect to reproduce arbitrary changes in the prescribed luminance or illuminance which occur over angles less than 15 degrees.

The optical properties of these (and other) collimating horns can be understood within the context of a simple approximate image method, as known to one of skill in the art. Generally, the most useful collimating horns are those whose optical properties are the simplest. For example, a square horn for which (W_{>}−W_{<})/(\sqrt{2}H)<<1 emits the same circularly-symmetric angular distribution of luminance from every point on its outlet. Simplicity derives from configurations which force multiple reflections from the interior faces of the horn. Therefore, extreme high-reflectivity mirror finishes are a premium for useful collimating horns.

The highest-reflectivity mirror finishes known are those provided by multi-layer polymer films, such as Vikuiti™ Enhanced Specular Reflective (ESR) films, available from 3M Company. These films can be laminated to structural elements which form the side panels (trapezoidal faces) of the horn prior to assembly of these elements into a horn. They can provide specular reflectivities usually exceeding 98 percent, substantially independent of incidence angle and wavelength over the visible portions of the electromagnetic spectrum. No know metallic finishes deliver comparable levels of performance.

The sole detriment of multi-layer polymer films relative to metallic finishes is their potential photo-degradation under exposure to extreme fluxes, as might occur in collimating horns used for lighting. The areal density of potentially-harmful power incident upon the interior surfaces of the side panels of a horn as a function of position relative to the inlet can be evaluated, and may lead to the utilization of metallic finishes only in regions of harmful exposure, thereby maximally preserving the benefit of multi-layer polymer films.

FIG. 1B shows a schematic perspective view of a lighting element 100, according to one aspect of the disclosure. Each of the elements 100-152 shown in FIG. 1B correspond to like-numbered elements 100-152 shown in FIG. 1A, which have been described previously. For example, input end 110 shown in FIG. 1B corresponds to input end 110 shown in FIG. 1A, and so on. In FIG. 1B, lighting element 100 shows pointing direction 152 of light collimating horn 101 is directed perpendicularly to a target surface 160 on the X-Y plane. Light source 105 (not shown) located within input end 110, injects a nearly lambertian light distribution which is shaped by reflections from the light collimating horn 101 until the light has a distribution of luminance comprising an input light beam 150 having a collimation half-angle θ₀ defined by boundary rays 154, along pointing direction 152. Input light beam 150 intercepts structured refraction surface 144 of redistribution plate 140, and reshapes the partially-collimated angular distribution of incident luminance from the light source 105 to match a prescribed angular distribution of transmitted luminance. In FIG. 1B, for example, this is shown as the input light beam 150 intercepting the redistribution plate over the output end 120 is reshaped into an angular distribution of transmitted luminance 150′ that exits the opposing output surface 142 of redistribution plate 140, and intercepts the target surface 160 in a rectangular region having widths “W1” and “W2”.

It is to be understood that depending on the orientation of the pointing direction 152 (i.e., the tilt of the light collimating horn 101 relative to the target surface 160) and the design of the redistribution plate 140, an output pointing direction 152′ may not be coincident with the pointing direction 152 as shown in the FIG., but may instead be directed to another location on the X-Y plane, as described elsewhere. Generally, the output pointing direction 152′ can correspond to a central location of the angular distribution of transmitted luminance 150′ on target surface 160 from the lighting element 100, such that the position of the angular distribution of transmitted luminance 150′ can be described by an offset of the central output pointing direction 152′ from the pointing direction 152.

Redistribution plates 140 suitable for use in the present disclosure include those made by the techniques described above. An input light beam 150 having light rays within an input collimation half-angle θ₀ of a pointing direction 152 (i.e., a first angular distribution of light rays), intersect the redistribution plate 140 (or film), and are converted to an angular distribution of transmitted luminance 150′ having light rays within an output collimation half-angle θ₀′ of a central output pointing direction 152′ (i.e., a second angular distribution of light rays). The redistribution plate 140 can serve the function of mixing/blending of light from a single light source, or mixing/blending light from multiple light sources. The redistribution plate 140 has a surface that includes an optimal slope distribution for reshaping the input light beam 150 in order to match a prescribed distribution of transmitted light. For each combination of input light beam 150 and desired angular distribution of transmitted luminance 150′, there is a family of surfaces that have a slope distribution suitable to effect the transformation; however, the optimal slope distribution most closely matches the desired light output.

The majority of the input light rays pass through the structured refraction surface 144 of the redistribution plate 140, are refracted into different directions determined by the local slope of the structure, and pass through the opposing output surface 142 in an output direction. For these light rays, there can be, if desired, no net change in the direction of propagation along the pointing direction 152; however, the structured refraction surface 144 can include microstructures such as tapered protrusions that can effect a change in the direction of propagation in two orthogonal directions. In some cases, the tapered protrusions can be complex shapes that include local slopes that are calculated by iterative, numerical, or analytical techniques in order to distribute the incident light in more complex output distribution. In some cases, the tapered protrusions can be arranged in a random pattern, arranged in a rectangular pattern, arranged in a square pattern, arranged in a hexagonal pattern, arranged in a herringbone pattern, or arranged in a combination pattern thereof. The net change in direction is determined by the index of refraction and the distribution of surface slopes of the structure. The redistribution plate microstructure can include smooth- or irregular-curved surfaces similar to spherical or aspheric lenses, or can be piecewise planar, such as to approximate smooth curved lens structures, or can include diffuser characteristics, holographic characteristics, Fresnel characteristics, and the like. In general, the structured refraction surface 144 of the redistribution plate 140 can be selected to yield a specified distribution of illuminance upon target surfaces 160 occurring at distances “D” from the output end 120 which are large compared to the cross-duct dimension of the emissive surface (i.e., the far-field image). The structured refraction surface 144 of the redistribution plate 140 can also be selected to yield homogenization of the uniformity of both color and intensity of light intercepting the target surface 160.

The redistribution plate 140 can be designed, for example, such that for a conical distribution of light input to the redistribution plate 140, the light output can be a square or rectangular distribution of light output. In one particular embodiment, the redistribution plate 140 was designed to take an input distribution of luminous intensity that was essentially uniform in a cone having a collimation half-angle θ₀ (i.e., input light beam 150 having a central light ray coincident with pointing direction 152, boundary rays 154 and collimation angle θ₀), and convert it to an output angular distribution of transmitted luminance 150′ having a central output pointing direction 152′, boundary rays 154′ and maximum output collimation half-angle θ₀′) that was essentially uniform on a rectangular target surface 160 having side lengths “W1” and “W2” located a distance “D” from the exit of the redistribution plate 140, and perpendicular to the pointing direction 152. The output distribution of luminous intensity is thus confined primarily to a beam having a maximum output collimation half-angle θ₀′.

For the design of this redistribution plate 140, the input end 110 was assumed to be small relative to the other dimensions (i.e., the distance from the plate to the target, “D”, and the size of the target, “W1”×“W2”), and the input distribution of light can be defined in terms of luminous intensity (Watts/Steradian) and not luminance (Watts/sq-meters/Steradian). In one particular embodiment, the angular distribution of transmitted luminance 150′ casts a prescribed distribution of illuminance upon a target surface 160 that is separated from the output end by a distance greater than four times a maximum dimension of the output end 120.

In general, the redistribution plate 140 can be designed such that an input light with a first distribution and collimation angle is mapped to an output distribution that is within 70% of a calculated illuminance value, or within 75% of a calculated illuminance value, or within 80% of a calculated illuminance value, or within 85% of a calculated illuminance value, or even within 90% or more of a calculated illuminance value. The calculated illuminance value can be determined by the minimum that is specified for use in the illuminated area.

In one particular embodiment, the squared deviation between an attained angular distribution of transmitted luminance and the prescribed angular distribution of transmitted luminance is a minimum value, as described elsewhere. In some cases, the structured refraction surface 144 is designed such that an input light beam 150 having a first distribution and collimation angle is mapped to an output distribution having a root mean square (RMS) deviation from the prescribed distribution of no more than 1.30 times the minimum value, or no more than 1.25 times the minimum value, or no more than 1.15 times the minimum value, or no more than 1.10 times the minimum value. The minimum possible value is the minimum possible squared deviation between the prescribed distribution and that output by single-pass transmission through any single-sided structure illuminated by the input light distribution.

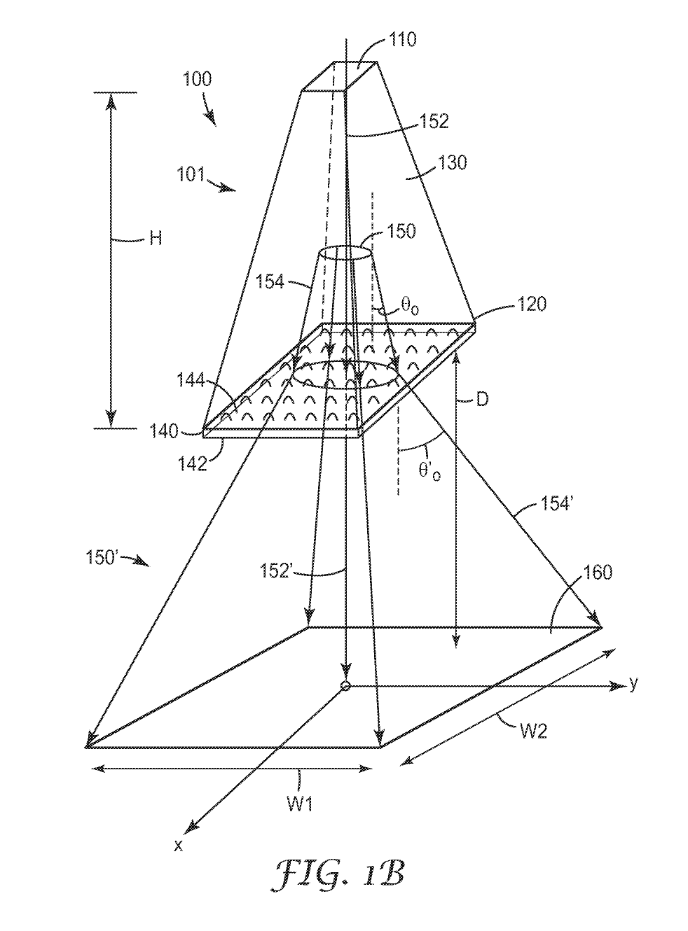

FIGS. 2A-2E show schematic side views of lighting element orientations, according to one aspect of the disclosure. Each of the elements 200-260 shown in FIGS. 2A-2E correspond to like-numbered elements 100-160 shown in FIG. 1B, which have been described previously. For example, input end 210 shown in FIG. 2A corresponds to input end 110 shown in FIG. 1B, and so on. FIG. 2A shows lighting element 200 aligned such that the pointing direction 252 is perpendicular to the target surface 260. A redistribution plate 240a can be designed such that the output pointing direction 252a′ is coincident with pointing direction 252.

FIG. 2B shows lighting element 200 aligned such that the pointing direction 252 is perpendicular to the target surface 260. A redistribution plate 240b can be designed such that the output pointing direction 252b′ is not coincident with pointing direction 252, but instead intercepts target surface 260 at an intercept angle φ.

FIG. 2C shows lighting element 200 aligned such that the pointing direction 252 is oriented at an intercept angle φ to the target surface 260. A redistribution plate 240c is designed such that the output pointing direction 252c′ is coincident with pointing direction 252.

FIG. 2D shows lighting element 200 aligned such that the pointing direction 252 is oriented at an intercept angle φ to the target surface 260. A redistribution plate 240d can be designed such that the output pointing direction 252d′ is not coincident with pointing direction 252, but either intercepts target surface 260 or an alternate target surface 261 disposed at an alternate target surface angle β to target surface 260. In some cases, target surface 260 can be a floor of a room, and alternate target surface 261 can be a wall, such that alternate target surface angle β=90 degrees.

FIG. 2E shows lighting element 200 aligned such that the pointing direction 252 is oriented parallel to the target surface 260. A redistribution plate 240e can be designed such that the output pointing direction 252e′ is directed to intercept target surface 260.

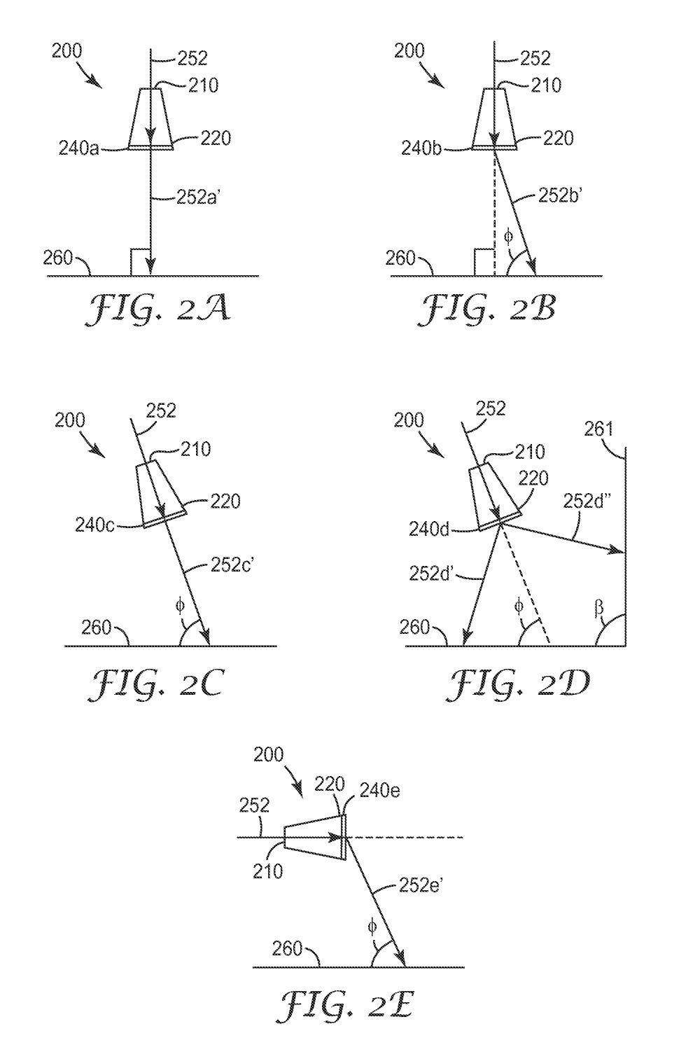

FIG. 3 shows a schematic cross-sectional view of a linear array luminaire 301, according to one aspect of the disclosure. Each of the elements 300a-360 shown in FIG. 3 corresponds to like-numbered elements 100-160 shown in FIG. 1B, which have been described previously. For example, each of input end 310a, 310b, 310c shown in FIG. 3 corresponds to input end 110 shown in FIG. 1B, and so on. In FIG. 3, linear array luminaire 310 includes a first, second, and third lighting element 300a, 300b, 300c, respectively, that can be used to illuminate an illumination region 365 of target surface 360. The first, second, and third lighting element 300a, 300b, 300c can be positioned immediately adjacent each other such that each of the associated output ends are coplanar and are tiled to uniformly fill an output end 320 emitting area, and the light redistribution plate 340 can be a unitary plate that is positioned adjacent the output end 320 emitting area. In some cases, individual light redistribution plates 340 can instead be positioned adjacent each of the first, second, and third lighting element 300a, 300b, 300c, as described elsewhere, but not shown in FIG. 3.

A first, second, and third angular distribution of transmitted luminance 350a′, 350b′, 350c′ emitted from the first, second, and third lighting element 300a, 300b, 300c, respectively, are directed toward illumination region 365. The first, second, and third angular distribution of transmitted luminance 350a′, 350b′, 350c′ are interposed on each other, such that the illuminated region 365 becomes dimmer with the removal of any of the first, second, and third lighting element 300a, 300b, 300c, but the distribution of the light across the region does not vary.

Another way of stating the uniform illumination of a surface by the luminaire is that in general, for a luminaire having an array of lighting elements, each having at least one light source, the prescribed distribution of transmitted luminance from each of the lighting elements casts a prescribed distribution of illuminance upon a target surface such that adjacent light collimating horns substantially illuminate the same target surface with the same prescribed distribution of illuminance. In some cases, an intensity, but not the prescribed distribution, of the illuminance is decreased by elimination of one or more of the at least one light sources.

Longer horns having a single output end can be compared to arrays of shorter horns having a comparable combined output end. In many applications the benefits of shortening and simplified thermal management may outweigh concerns regarding non-uniformity, so that short-horn light engines can be preferred. The potential broad utility of these engines spawns the need for a low-cost means of mass production. Two innate attributes of collimating horns facilitate their low-cost fabrication. First, each horn requires only four distinct optically-active surfaces, each of which is flat. Second, most emission undergoes multiple reflections, so that the impact of unintentional non-flatness tends to average to zero. Three approaches to fabricating short-horn engines are described. Two are based upon stamping and bending ESR-lined sheet metal. The third is based upon a combination of stamped ESR-lined pieces and an aluminum extrusion.

An M×N array of illuminated horns can be fabricated by stamping and bending a suitable base plate using two types of internal pieces and two types of edge pieces. Initially, a MW_{>}×NW_{>} (or larger) base plate is fabricated containing M×N individual LEDs or LED clusters, complete with electrical and thermal connections, disposed on a square grid with pitch W_{>}, positioned centered on the plate. Then the internal and edge pieces, fabricated by stamping and bending ESR-lined sheet metal, can be attached to the base plate and/or to each other so that one LED or LED cluster is centered in the inlet of each of the resultant horns. Attachment, anchoring, and stabilization of the parts can be achieved using any combination of etched or molded guide lines or grooves in the base plate, adhesives between the pieces and the base plate, rods threaded cross-wise through the long pieces and centered to support the centerline of each small piece, or tabs and slots along the edge of each trapezoidal face, as known to one of skill in the art.

An alternate approach also based upon stamping and bending ESR-lined sheet metal can include the following steps. A linear array of horns, each having four sidewalls can be formed by inserting a horn ‘module’ including an input end and first two opposing horn sidewalls into a horn ‘rail’, which is a continuous trough having the second two opposing sidewalls, configured to accept the input end and the first two opposing horn sidewalls. Each module contributes two opposing faces and the inlet of a horn, along with an LED or LED cluster with electrical and thermal connections. The rail contributes the remaining two faces of each horn created by inserting a module. The modules can be provided with threaded posts which align with holes in the rail for alignment and attachment, and pins or wires on the inlet which align with another hole for the transfer of electrical connections exterior to the array. Rails can be provided in a single standard length NW_{>} to accommodate an integral number N of modules, and scored at intervals of W_{>} to permit easy separation into shorter integral segments. This architecture enables fabrication of any rectangular array from multiple copies of just two standard components. Linear segments populating a larger linear or rectangular array can be secured by a custom ESR-lined collar congruent with the perimeter of the larger array and possibly extending beneath the outlets to permit some mixing within a confined area of the output of individual horns. Such mixing can eliminate the grid of dark lines along boundaries between horns that might otherwise appear in the emission of a luminaire fed by the array.

The functionality of the rail described above might instead be provided by an aluminum extrusion whose optical surfaces are polished, vapor coated, or preferably lined with ESR. Extrusion can create a more substantial and aesthetically-pleasing device, and allows for the inclusion of additional features such as a wireway running along the input end of the rail. The extrusion can be converted to a linear array by post processing. For example, ESR-lined flat plates can be inserted into a series of cross cuts in the extrusion. Linear arrays of any integral number of elements can be created by cutting the extrusion to an appropriate length in post processing. This includes the possibility of creating individual horns as well as arrays. These linear horns might be reassembled into a linear array by, for example, passing one cylindrical support and electrical-feed rod through circular holes in the wireways of several horns, allowing for arbitrary spacing between horns and even the freedom to adjust the orientation of each horn about its pivot.

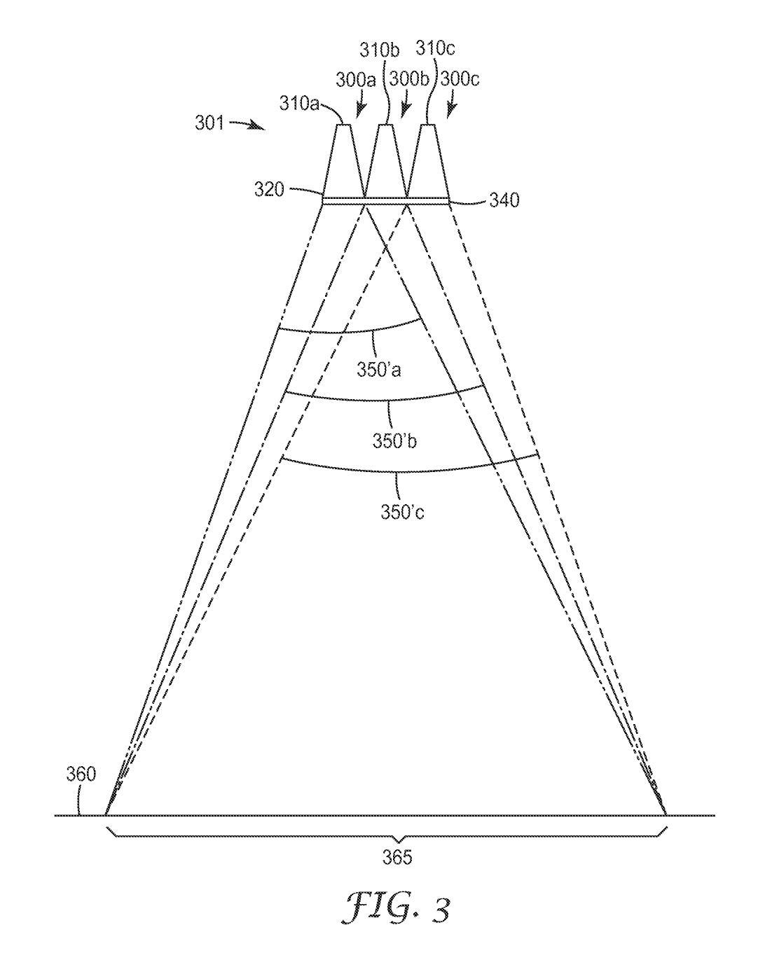

FIG. 4 shows a perspective view of a rectangular array luminaire 401, according to one aspect of the disclosure. Each of the elements 400-442 shown in FIG. 4 corresponds to like-numbered elements 100-142 shown in FIG. 1B, which have been described previously. For example, lighting element 400 shown in FIG. 4 corresponds to lighting element 100 shown in FIG. 1B, and so on. Rectangular array luminaire 401 includes a plurality of lighting elements 400 positioned immediately adjacent a neighboring lighting element 400. The rectangular array luminaire 401 can be a square array as shown in FIG. 4, or it can have other rectangular shapes. In some cases, the output ends of adjacent light collimating horns of the lighting elements 400 are coplanar and are tiled together to uniformly fill a common output end 420 emitting area, and the light redistribution plate 440 can be a unitary plate that is positioned adjacent the output end 420 emitting area. In some cases, individual light redistribution plates 440 can instead be positioned adjacent each of the lighting elements 400, as described elsewhere, but not shown in FIG. 4.

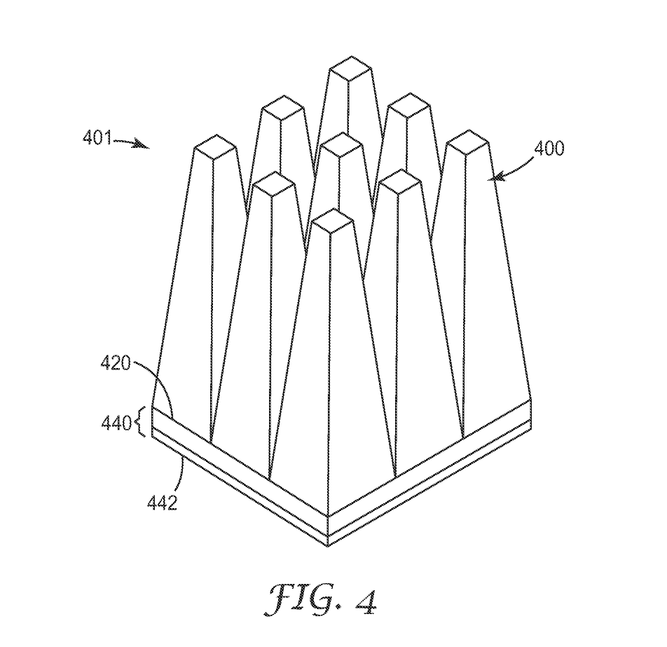

FIGS. 5A-5C show schematic side views of luminaire illumination, according to one aspect of the disclosure. In FIG. 5A, a luminaire 500 is positioned in illuminated room 501 such that an angular distribution of transmitted luminance 550′ is directed toward illuminated region 565 on target surface 560. In some cases, luminaire 500 can include only one lighting element, or it can include an array of lighting elements, as described elsewhere. In one particular embodiment, luminaire 500 can be positioned on a ceiling of illuminated room 501, and the illuminated region 565 can include, for example, artwork or a retail display positioned on the target surface 560, which can be a wall of the illuminated room 501. In some cases, luminaire 500 can extend below the ceiling as shown in FIG. 5A; however, in some cases luminaire 500 can instead be embedded within the ceiling or soffit, for aesthetics or other reasons. In one embodiment, other portions of the illuminated room 501 may lack other illumination.

In FIG. 5B, a luminaire 500 is positioned in illuminated room 502 such that an angular distribution of transmitted luminance 550′ is directed toward illuminated region 565′ on target surface 560 and alternate target surface 561. In some cases, luminaire 500 can include only one lighting element, or it can include an array of lighting elements, as described elsewhere. In one particular embodiment, luminaire 500 can be positioned on a ceiling of illuminated room 502, and the illuminated region 565′ can include, for example, artwork or a retail display positioned both on the target surface 560 (which can be a floor of the illuminated room 502), and also on the alternate target surface 561 (which can be a wall of the illuminated room 502). In some cases, luminaire 500 can extend below the ceiling as shown in FIG. 5B; however, in some cases luminaire 500 can instead be embedded within the ceiling or soffit, for aesthetics or other reasons. In one embodiment, other portions of the illuminated room 502 may lack other illumination.

In FIG. 5C, a luminaire 506 is positioned proximate the top end of a light pole 504, and can be used to illuminate a target surface 560, for example, an outdoor parking lot. In some cases (not shown), luminaire 506 can instead be positioned on the ceiling of a structure such as a parking garage, auditorium or indoor arena, and the pole may be eliminated. Luminaire 506 includes a first lighting element 500a having a first pointing direction 552a, and a second lighting element 500b having a second pointing direction 552b. First lighting element 550a directs a first angular distribution of transmitted luminance 550a′ toward a first illumination region 565a on target surface 560, and second lighting element 550b directs a second angular distribution of transmitted luminance 550b′ toward a second illumination region 565b on target surface 560. First and second illumination regions 565a, 565b can overlap, or they can be separated by a non-illuminated region.

It is to be understood that luminaire 506 can include any of the arrays of lighting elements as described elsewhere, and can also include lighting elements positioned in orientations such that the associated pointing directions point both into—and out of—FIG. 5C as illustrated. For example, in some cases, first and second pointing directions 552a, 552b, can be in a plane perpendicular to the target surface 560, and a third and fourth pointing direction (not shown) can be in a plane both perpendicular to the target surface 560, and the plane including the first and second pointing directions 552a, 552b.

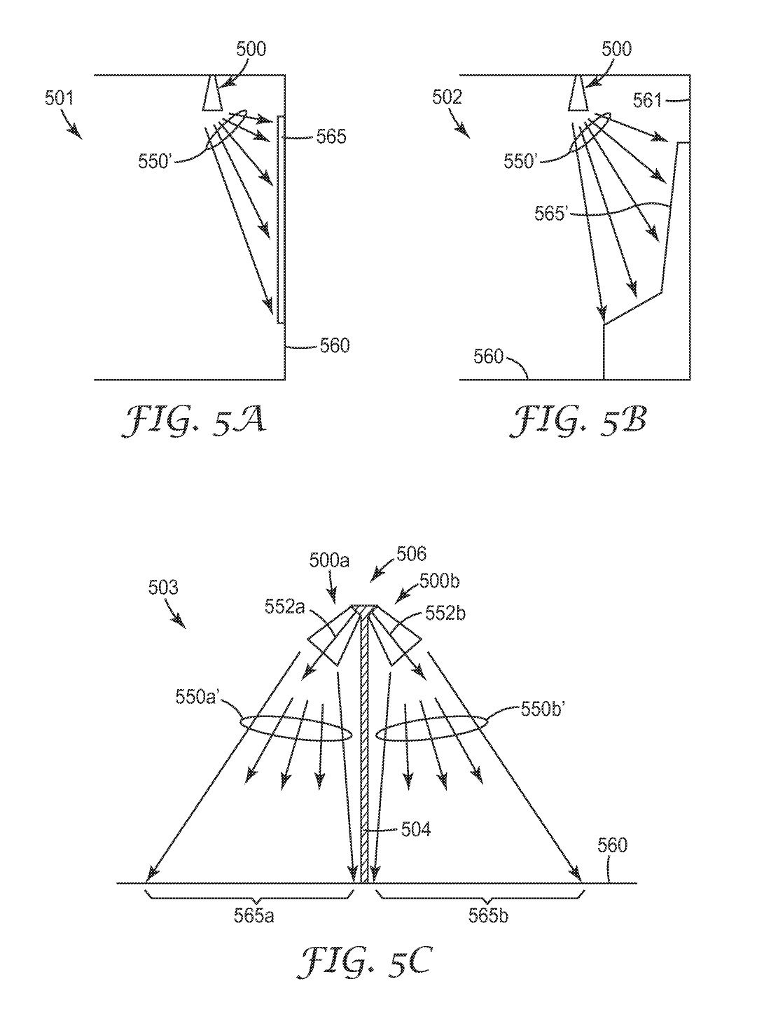

FIG. 6 shows a tilted perspective view of a luminaire 606, according to one aspect of the disclosure. In one particular embodiment, luminaire 606 can be the luminaire 506 described on the top of a light pole in FIG. 5. Luminaire 606 includes a first, a second, a third, and a fourth lighting element arrays 601a, 601b, 601c, 601d disposed in a housing 690 that at least partially encloses the arrays of lighting elements. In some cases, the housing 690 can also include a wireless control (not shown) for operation of each light source. Each of the first, second, third, and fourth lighting element arrays 601a, 601b, 601c, 601d include four lighting elements 600 disposed in a linear array. Each of the resulting 16 lighting elements are aligned such that when the luminaire 606 is positioned on the top end of the light pole, the pointing directions are collectively arranged in a four-sided pyramid shape directed toward the target surface. A separate light redistribution plate (not shown) is positioned adjacent the output end of each of the lighting elements 600, as described elsewhere.

A luminaire can be constructed using multiple canted horn arrays with each horn array having a redistribution plate on the output surface. The horn arrays can be arranged to reduce the required refractive bending angle of light and assist production of a desired target coverage profile of illuminance over a target surface. Each horn array can be canted by a beam angle relative to the direction normal to the (square) target surface. Each array can be placed about the center axis so that it illuminates primarily a disjoint region of the target. In some cases, the design can allow for some overlap of the illumination profiles from the individual arrays. The redistribution plates can be designed to take overlap of the individual light sources into account.

In some cases, more than one beam angle may be employed (different arrays may be canted by different angles) to enhance the illumination in regions on the target close to or far from the axis of symmetry of the luminaire. More than one type redistribution plate may also be used on the horn arrays, depending on the horn location and/or orientation. The horn arrays on each portion of the luminaire do not have to be identical. Depending on the area of the sub-region on the target covered, any given array in the assembly might have more, less, or the same number of collimating horns and concomitant number of LEDs than others.

One benefit of the luminaire design described is that it has extremely effective thermal management properties. High power light-emitting diodes can be driven aggressively while maintaining a relatively low junction temperature. This enables a high intensity light source that also has a high luminous efficacy. A typical Cree XLamp XTE LED has a luminous efficacy equal to 122 lm/Watt, when operating at a temperature of 85 C. Integrating sphere measurements of beam modules (modular horn arrays) suggest that due to superior heat management, the horn arrays can be significantly more efficient.

### EXAMPLES

### Example 1

### Luminaire Having a Inear Array of Light Collimating Horns

A linear array of six collimating horns was assembled into a luminaire using a 12 inch (30.5 cm) long ESR lined rail, and six ESR-lined modules each incorporating one Cree XT-E LED centered on the inlet were positioned in the ESR lined rail. The dimensions of the resulting horn were: W_{<}=0.5 in (1.27 cm), W_{>}=2.0 in (5.08 cm), H=4.5 in (11.43 cm), and collimation half-angle was

$${ψ}_{1 / 2} = {sin}^{- 1} ( \frac{{W}_{<}}{{W}_{>}} ) = 14 ° .$$

The emitted flux, measured in an integrating sphere while the six modules were driven in series at 350 mA and 17.9 V, was 815 Lm. The corresponding luminous efficacy is 130 Lm/W, and the corresponding areal density of delivered collimated flux was 4890 Lm/ft². The average manufacturer's-specified luminous efficacy of the six LEDs used is 137.5 Lm/W, indicating 95-percent optical efficiency. The steady-state temperature measured on the surface immediately exterior to an LED was 45° C. These results confirm the high optical efficiency and high luminous efficacy of the lighting element, and demonstrate the potential for large collimated fluxes from small areas, and exceptional thermal management without heat sinks or fans.

### Example 2

### Illumination of a Horizontal Plane by an Array of Luminaires

The uniform illumination of a horizontal plane surface by a square grid of luminaires within an overlying parallel plane, such as a ceiling, when the normal separation of the planes is H and the pitch of the grid is P=H, was modeled. The luminaires were positioned on an 8-foot by 8-foot grid recessed within an 8-foot ceiling, illuminating a space where 50 fc uniform illuminance was desired upon the floor.

Each luminaire consists of a two-dimensional array of horns composed of the elements described for Example 1. These are ESR-lined horns with uniformity of emission characterized by (W_{>}−W_{<})/(\sqrt{2}H)=1/(\sqrt{2}3). The horns were driven so that each delivers 135 Lm without a redistribution plate, and 128 Lm with a redistribution plate. A luminaire comprising a five-by-five array of these elements with a redistribution plate would deliver 25×128=3200 Lm, equal to the flux needed to achieve uniform 50 fc illumance over a 64 ft² area. The expected power consumption was 26 W per luminaire.

The steering plate was a two-dimensional structure compression molded on the top side of a polycarbonate sheet, laminated to a polycarbonate support plate without a bottom-surface AR coat. Optically, the plate resembles a uniform index-1.6 element, and was modeled as such. The plate was cut to match the dimensions of the five-by-five horn array, and was affixed immediately adjacent to the outlets with the structure facing the horns. The structure was chosen to minimize the squared deviation from the mean in the illuminance cast upon the floor within an 8-foot by 8-foot square centered under the center luminaire of a three-by-three square array of identical luminaires on the ceiling. The resultant structure is such that the emission from each luminaire is nearly entirely confined within a 24-foot by 24-foot square centered beneath that luminaire, meaning that only the overhead and nearest and next-nearest neighbors contributed to the localized illuminance beneath each luminaire. It follows that uniform illuminance was achieved over arbitrary areas except within 8 feet of the edge of the space.

The presence of the redistribution plate both smoothed the illuiminance and substantially broadened the pattern, so that it extended well beyond the perimeter of the target area. The striking uniformity of illuminance delivered by the array of luminaires with redistribution plates was plainly evident from the modeling. The uniformity of illuminance within the target area, as measured by the ratio of the minimum to maximum value, was 0.87, a degree of uniformity presently unheard of in large-area lighting.

### Example 3

### Luminaire Having a Linear Array of Lighting Elements

A linear luminaire having an array of square horns with W_{<}=0.25 in (0.635 cm) input end, W_{>}=1 in (2.54 cm) output end, and centerline height H=3 in (7.62 cm). The half angle of collimation was

$${ψ}_{1 / 2} = {sin}^{- 1} ( \frac{0.25}{1} ) = 14 ° ,$$

and the uniformity of emission was given by (W_{>}−W_{<})/H=¼. The horn array included a 0.25-inch (0.635 cm) collar enclosing the combined perimeter of the outlets to eliminate dark lines at the boundaries between horns that would otherwise appear in views of the emissive surface of the luminaire.

A single rectangular redistribution plate was disposed immediately adjacent to the outputs, cut to match the length of the array. The plate had a down-web one-dimensional microstructure, replicated in an index-1.6 resin, on a PET substrate, laminated to a polycarbonate plate with a bottom-surface AR coat. Optically, the plate resembled a uniform index-1.6 element, and was modeled as such. Linear luminaires require steering of their emission only in the transverse direction, which was accomplished by a one-dimensional structure. Three different structures were designed for the redistribution plate. These provided uniform illuminance on a horizontal surface over ±22.5°, +30°, or ±40° swaths centered below the luminaire.

The horns and the collar were lined with ESR. While the total reflectivity of ESR is often as high as 99 percent, there sometimes occurs a small diffuse (and nearly Lambertian) component to this total, perhaps as large as two percent. To contribute to an emerging understanding of the possible effects of a diffuse component, each of the interior surfaces were modeled as 97-percent specular, and 2-percent Lambertian, reflective. Each of the horn input ends was populated by an LED or cluster of LEDs delivering a maximum of 100 Lm of Lambertian-distributed flux. The corresponding maximum linear density of source flux was 1200 Lm/ft.

The second and third columns in Table 1 summarize the calculated optical efficiency of the luminaire and the corresponding total emitted flux at the maximum drive current for each of the bare horn array and the horn array in combination with each of the redistribution plates. The efficiency of the bare horn array was very high, despite the assumption of perfect absorption over 64 percent of the inlet. The efficiency remained very high when any of the redistribution plates was included. This was because the structures were designed for single-pass extraction, including an AR coat on the bottom of the plate, and much of the small amount reflected by the plates is returned by the horn without reaching the inlet. The maximum Illuminance in fc (foot-candles) is provided for four different heights above the target surface in columns 3-6, and the maximum Luminance in Cd/m² for both longitudinal and transverse glare (angles >45 degrees) and over the Illumination zone, are provided in columns 7-9 of Table 1.

TABLE 1
Performance of Luminaires

| | | | Max | Max | Max | Max | Glare | Glare | |
|---|---|---|---|---|---|---|---|---|---|
| | | Emitted | Illum, | Illum, | Illum, | Illum, | (>45°) | (>45°) | Illumination |
| | Eff | Flux | H = 6 | H = 8 | H = 10 | H = 12 | Long. | Trans. | Zone |
| Type | % | Lm/ft | ft fc | ft fc | ft fc | ft fc | Cd/m² | Cd/m² | Cd/m² |
| horn | 96.3 | 1156 | 480 | 360 | 288 | 240 | 1900 | 1900 | 900,000 |
| ±22.5° | 95.2 | 1142 | 220 | 165 | 132 | 110 | 2200 | 13000 | 450,000 |
| ±30.0° | 94.8 | 1138 | 160 | 120 | 96 | 80 | 2350 | 16000 | 380,000 |
| ±40.0° | 94.7 | 1136 | 120 | 90 | 72 | 60 | 2800 | 130000 | 300,000 |

Each of the ±22.5° and ±30° luminaires exhibited a maximum luminance in the transverse glare zone nearly equal to the threshold for visual discomfort. However, for any luminaire height less than 12 feet, the transverse glare diminishes well beneath the threshold when the drive current is reduced so as to deliver 50 fc illuminance. The ±40° luminaire exhibited a maximum on the edge of the transverse zone an order of magnitude above the threshold for discomfort. It remained well in excess of the threshold even when the drive current was reduced to deliver 50 fc. This is because the intended illumination extended to the edge of the glare zone in the transverse direction, and the luminance will be high given that the emitting area is so small.

The luminance emitted less than 45 degrees removed from vertical is usually considered in the ‘illumination zone’, and does not contribute to glare. The maximum area-averaged luminance emitted by the luminaires within the illumination zone is summarized in the last column of Table 1. These values are very high and capable of creating extreme discomfort. Again, this is inevitable for any luminaire providing intense illumination from a small emitting surface. The conventional wisdom is to not stare at the light from within the illumination zone.

### Example 4

### Luminaire for Lighting in a Parking Garage

A luminaire was designed and constructed to demonstrate lighting in a parking garage. The luminaire was similar to the design shown in FIG. 6, and was elevated from the target surface (the garage deck) by about 7 feet (2.13 meters), similar to the design shown in FIG. 5. For parking garages, the width dimension of the illuminated space was on the order of 30 feet (9.14 meters). A typical parking “module” covers a 30-by-60 foot (9.14×18.28 meters) space illuminated by two luminaires. The angle from a luminaire mounted at the center of a 30-by-30 foot (9.14 meter) square half of a parking module to the near edge of the 30-by-30 foot (9.14 meter) square was 65 degrees, and the angle to the far corner of the same square was 72 degrees. The square cross-section horns had input dimension 0.5 inches (1.27 cm), output dimension 2.0 inches (5.08 cm), length 4.5 inches (11.43 cm) and are canted at an angle of 45 degrees.

The luminaire for illuminating a square target included four canted horn arrays arranged to reduce the required refractive bending angle of light by as much as 25 degrees. The four horn arrays comprising the example luminaire design are canted by a single fixed beam angle relative to the direction normal to the (square) target surface. Each array was placed symmetrically about the center axis so that it illuminated primarily a disjoint quadrant of the target. The design purposely allowed for some overlap of the illumination profiles from the individual arrays and the redistribution plate was designed to take overlap of the individual light sources into account.

The redistribution plate was micro-replicated with structures designed using the technique described above, and was fastened to the exterior of each of the four modular horn arrays with the structures pointing inward. The redistribution plate was designed using a weighted technique that accounted for and balances the uniformity of coverage from one luminaire versus the uniformity of coverage from a periodic array of luminaires over the central 30×30 foot square target. An light-redirecting structure designed using a weight factor of 0.1 for the isolated luminaire and a weight factor of 0.9 for the periodic array of luminaires is shown in FIG. 7. The light-redirecting structures were replicated using laser mastering, and replicates were made both by compression molding and continuous cast and cure web processing.

The illuminance profile for the luminaire with light redirecting films over a target was computed via optical ray tracing using LightTools and custom Matlab scripts. The minimum-to-maximum uniformity predicted for the luminaire in a periodic array was about 0.62, which exceeds the Illumination Engineering Society of North America (IESNA) guideline of 0.1. A predicted goniometric (Candela) plot was created for the downward luminous intensity for the luminaire, and showed that only about 2.6 percent of the total emitted light is sent to the ceiling of the parking garage. In general, the luminaire was shown to have significantly less glare than the bare LEDs in the luminaire, since the maximum luminous intensity was about two orders of magnitude lower than the luminous intensity of a bare LED (about 5 million Candela for a 1.5 mm square Lambertian LED emitting 122 lumens).

Following are a list of embodiments of the present disclosure.

Item 1 is a lighting element, comprising: a light collimating horn having an input end, an output end, and horn sidewalls connecting the input end to the output end; a light source having an emitting surface disposed within the input end; and a redistribution plate disposed adjacent the output end of the light collimating horn, the redistribution plate having a structured refraction surface facing the input end, wherein the redistribution plate is capable of reshaping a partially-collimated angular distribution of incident luminance from the light source to match a prescribed angular distribution of transmitted luminance.

Item 2 is the lighting element of item 1, wherein the squared deviation between an attained angular distribution of transmitted luminance and the prescribed angular distribution of transmitted luminance is a minimum.

Item 3 is the lighting element of item 1 or item 2, wherein the input end and the output end are parallel.

Item 4 is the lighting element of item 1 to item 3, wherein the structured refraction surface is immediately adjacent the output end.

Item 5 is the lighting element of item 1 to item 4, wherein each dimension of the output end is equal to or greater than a corresponding dimension of the input end.

Item 6 is the lighting element of item 1 to item 5, wherein the light collimating horn comprises a hollow horn having a specularly reflective interior surface.

Item 7 is the lighting element of item 6, wherein the specularly reflective interior surface comprises an inorganic interference reflector, an organic interference reflector, a metallic reflector, a metalized polymeric film reflector, or a combination thereof.

Item 8 is the lighting element of item 1 to item 7, wherein the redistribution plate comprises a polymeric film.

Item 9 is the lighting element of item 1 to item 8, wherein the structured refraction surface comprises tapered protrusions.

Item 10 is the lighting element of item 1 to item 9, wherein the structured refraction surface is designed such that an input light having a first distribution and collimation angle is mapped to an output distribution having a root mean square (RMS) deviation from the prescribed distribution of no more than 1.30 times a minimum value.

Item 11 is the lighting element of item 1 to item 10, wherein the structured refraction surface is designed such that an input light having a first distribution and collimation angle is mapped to an output distribution having an RMS deviation from the prescribed distribution of no more than 1.25 times a minimum value.

Item 12 is the lighting element of item 1 to item 11, wherein the structured refraction surface is designed such that an input light having a first distribution and collimation angle is mapped to an output distribution having an RMS deviation from the prescribed distribution of no more than 1.15 times a minimum value.

Item 13 is the lighting element of item 1 to item 12, wherein the structured refraction surface is designed such that an input light having a first distribution and collimation angle is mapped to an output distribution having an RMS deviation from the prescribed distribution of no more than 1.10 times a minimum value.

Item 14 is the lighting element of item 1 to item 13, wherein the prescribed distribution of transmitted luminance casts a prescribed distribution of illuminance upon a target surface that is separated from the output end by a distance greater than four times a maximum dimension of the output end.

Item 15 is the lighting element of item 1 to item 14, wherein the input end comprises a specular reflective surface, a diffuse reflective surface, or a combination thereof.

Item 16 is the lighting element of item 1 to item 15, wherein the input end comprises a heat sink.

Item 17 is the lighting element of item 1 to item 16, wherein the output end of the light collimating horn comprises a circular shape, an oval shape, a square shape, a rectangular shape, a hexagonal shape, or other polygonal shapes capable of tiling a planar surface.

Item 18 is the lighting element of item 1 to item 17, wherein the light collimating horn includes a square cross-section having an input end dimension Wᵢₙₚᵤₜ, an output end dimension Wₒᵤₜₚᵤₜ, and a centerline height H.

Item 19 is the lighting element of item 18, wherein |Wᵢₙₚᵤₜ−Wₒᵤₜₚᵤₜ|≦¼.

Item 20 is the lighting element of item 1 to item 19, wherein the redistribution plate comprises an anti-reflective coating on at least one of the structured refraction surface or an opposing major surface.

Item 21 is a luminaire, comprising: an array of lighting elements, each lighting element comprising: a light collimating horn having an input end, an output end, and horn sidewalls connecting the input end to the output end; a light source having an emitting surface disposed within the input end; and a redistribution plate disposed adjacent the output end of the light collimating horn, the redistribution plate having a structured refraction surface facing the input end, wherein the redistribution plate is capable of reshaping a partially-collimated angular distribution of incident luminance from the light source to match a prescribed angular distribution of transmitted luminance.

Item 22 is the luminaire of item 21, wherein the output ends of adjacent light collimating horns are coplanar.

Item 23 is the luminaire of item 21 or item 22, wherein collectively the output ends of the light collimating horns are tiled to uniformly fill an emitting area.

Item 24 is the luminaire of item 21 to item 23, wherein the array of lighting elements is a rectangular array.

Item 25 is the luminaire of item 24, wherein each lighting element in the rectangular array is positioned immediately adjacent a neighboring lighting element.

Item 26 is the luminaire of item 21 to item 23, wherein the array of lighting elements is a linear array.

Item 27 is the luminaire of item 26, wherein each lighting element in the linear array is positioned immediately adjacent a neighboring lighting element.

Item 28 is the luminaire of item 21 to item 27, wherein for a linear array of lighting elements having light collimating horns with a rectangular cross-section, the linear array of lighting elements comprise: a first modular component comprising at least one light source and opposing first sidewalls; and a second modular component comprising opposing second sidewalls, the opposing first sidewalls and opposing second sidewalls collectively forming the horn sidewalls.

Item 29 is the luminaire of item 28, wherein the first modular component and second modular component each comprise formed ESR-lined sheet metal.

Item 30 is the luminaire of item 28 or item 29, wherein heat generated by the at least one light source is dissipated by the ESR lined sheet metal.

Item 31 is the luminaire of item 21 to item 30, wherein for an array of lighting elements, each having at least one light source, the prescribed distribution of transmitted luminance from each of the lighting elements casts a prescribed distribution of illuminance upon a target surface such that adjacent light collimating horns substantially illuminate the same target surface with the same prescribed distribution of illuminance.

Item 32 is the luminaire of item 31, wherein an intensity, but not the prescribed distribution, of the illuminance is decreased by elimination of one or more of the at least one light sources.

Item 33 is the luminaire of item 21 to item 32, wherein the squared deviation between an attained angular distribution of transmitted luminance and the prescribed angular distributions of transmitted luminance is a minimum.

Item 34 is the luminaire of item 21 to item 33, wherein the input end and the output end are parallel.

Item 35 is the luminaire of item 21 to item 34, wherein the redistribution plate comprises an individual redistribution plate associated with each output end, a unitary redistribution plate associated with a plurality of output ends, or a combination thereof.

Item 36 is the luminaire of item 21 to item 35, wherein the structured refraction surface is immediately adjacent the output end.

Item 37 is the luminaire of item 21 to item 36, wherein each dimension of the output end is equal to or greater than a corresponding dimension of the input end.

Item 38 is the luminaire of item 21 to item 37, wherein the light collimating horn comprises a hollow horn having a specularly reflective interior surface.

Item 39 is the luminaire of item 38, wherein the specularly reflective interior surface comprises an inorganic interference reflector, an organic interference reflector, a metallic reflector, a metalized polymeric film reflector, or a combination thereof.

Item 40 is the luminaire of item 21 to item 39, wherein the redistribution plate comprises a polymeric film.

Item 41 is the luminaire of item 21 to item 40, wherein the structured refraction surface comprises tapered protrusions arranged in a random pattern, arranged in a rectangular pattern, arranged in a square pattern, arranged in a hexagonal pattern, arranged in a herringbone pattern, or arranged in a combination pattern thereof.

Item 42 is the luminaire of item 21 to item 41, wherein the structured refraction surface is designed such that an input light having a first distribution and collimation angle is mapped to an output distribution having an RMS deviation from the prescribed distribution of no more than 1.30 times a minimum value.

Item 43 is the luminaire of item 21 to item 42, wherein the structured refraction surface is designed such that an input light having a first distribution and collimation angle is mapped to an output distribution having an RMS deviation from the prescribed distribution of no more than 1.25 times a minimum value.

Item 44 is the luminaire of item 21 to item 43, wherein the structured refraction surface is designed such that an input light having a first distribution and collimation angle is mapped to an output distribution having an RMS deviation from the prescribed distribution of no more than 1.15 times a minimum value.

Item 45 is the luminaire of item 21 to item 44, wherein the structured refraction surface is designed such that an input light having a first distribution and collimation angle is mapped to an output distribution having an RMS deviation from the prescribed distribution of no more than 1.10 times a minimum value.

Item 46 is the luminaire of item 21 to item 45, wherein the prescribed distribution of transmitted luminance casts a prescribed distribution of illuminance upon a target surface that is separated from the output end by a distance greater than four times a maximum dimension of the output end.

Item 47 is the luminaire of item 21 to item 46, wherein the input end comprises a specular reflective surface, a diffuse reflective surface, or a combination thereof.

Item 48 is the luminaire of item 21 to item 47, wherein the input end comprises a heat sink.

Item 49 is the luminaire of item 21 to item 48, wherein the output end of the light collimating horn comprises a circular shape, an oval shape, a square shape, a rectangular shape, a hexagonal shape, or other polygonal shapes capable of tiling a planar surface. Item 50 is the luminaire of item 21 to item 49, wherein the light collimating horn includes a square cross-section having an input end dimension Wᵢₙₚᵤₜ, an output end dimension Wₒᵤₜₚᵤₜ, and a centerline height H.

Item 51 is the luminaire of item 50, wherein |Wᵢₙₚᵤₜ−Wₒᵤₜₚᵤₜ|/H≦¼.

Item 52 is the luminaire of item 21 to item 51, wherein the redistribution plate comprises an anti-reflective coating on at least one of the structured refraction surface or an opposing major surface.

Item 53 is the luminaire of item 21 to item 52, wherein each lighting element comprises a pointing direction from the input end to the output end and directed toward a target surface, each pointing direction forming an intercept angle with the target surface.

Item 54 is the luminaire of item 53, wherein at least one of the pointing directions is perpendicular to the target surface.

Item 55 is the luminaire of item 53 or item 54, wherein at least two of the pointing directions are in a plane perpendicular to the target surface.

Item 56 is the luminaire of item 53 to item 55, wherein at least two of the pointing directions forming the same intercept angle with the target surface.

Item 57 is the luminaire of item 53 to item 56, wherein the pointing directions collectively comprise a conical shape.

Item 58 is the luminaire of item 53 to item 57, wherein the pointing directions collectively comprise a pyramidal shape.

Item 59 is the luminaire of item 21 to item 59, wherein each lighting element comprises a pointing direction from the input end to the output end, at least one of the pointing directions parallel to a target surface.

Item 60 is the luminaire of item 59, wherein at least two of the pointing directions are directed radially outward from a central point.

Item 61 is a luminaire, comprising: an array of lighting elements, each lighting element comprising: a light collimating horn having an input end, an output end, horn sidewalls connecting the input end to the output end, and a pointing direction from the input end to the output end; a light source having an emitting surface disposed within the input end; and a redistribution plate disposed adjacent the output end of the light collimating horn, the redistribution plate having a structured refraction surface facing the input end, wherein each of the array of lighting elements is disposed adjacent a light pole top end extending from a target surface, the pointing directions collectively arranged in a pyramid shape directed toward the target surface, and wherein the redistribution plate is capable of reshaping a partially-collimated angular distribution of incident luminance from the light source to match a prescribed angular distribution of transmitted luminance.

Item 62 is the luminaire of item 61, wherein the pyramid shape is a four-sided pyramid and the array of lighting elements are arranged such that at least one lighting element has a pointing direction along each side of the four-sided pyramid.

Item 63 is the luminaire of item 61 or item 62, wherein the pyramid shape is a four-sided pyramid and the array of lighting elements are arranged such that four lighting elements have a pointing direction along each side of the four-sided pyramid.

Item 64 is the luminaire of item 61 to item 63, further comprising a housing at least partially enclosing the array of lighting elements.

Item 65 is the luminaire of item 61 to item 64, further comprising a wireless control for operation of each light source.

Unless otherwise indicated, all numbers expressing feature sizes, amounts, and physical properties used in the specification and claims are to be understood as being modified by the term “about”. Accordingly, unless indicated to the contrary, the numerical parameters set forth in the foregoing specification and attached claims are approximations that can vary depending upon the desired properties sought to be obtained by those skilled in the art utilizing the teachings disclosed herein.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A lighting element, comprising:
a light collimating horn having an input end, an output end, and horn sidewalls connecting the input end to the output end;
a light source having an emitting surface disposed within the input end; and
a redistribution plate disposed adjacent the output end of the light collimating horn, the redistribution plate having a structured refraction surface facing the input end,
wherein the redistribution plate is capable of reshaping a partially-collimated angular distribution of incident luminance from the light source to match a prescribed angular distribution of transmitted luminance.

2. The lighting element of claim 1, wherein the squared deviation between an attained angular distribution of transmitted luminance and the prescribed angular distribution of transmitted luminance is a minimum.

3. The lighting element of claim 1, wherein the input end and the output end are parallel.

4. The lighting element of claim 1, wherein the structured refraction surface is immediately adjacent the output end.

5. The lighting element of claim 1, wherein each dimension of the output end is equal to or greater than a corresponding dimension of the input end.

6. The lighting element of claim 1, wherein the light collimating horn comprises a hollow horn having a specularly reflective interior surface.

7. The lighting element of claim 6, wherein the specularly reflective interior surface comprises an inorganic interference reflector, an organic interference reflector, a metallic reflector, a metalized polymeric film reflector, or a combination thereof.

8. The lighting element of claim 1, wherein the redistribution plate comprises a polymeric film.

9. The lighting element of claim 1, wherein the structured refraction surface comprises tapered protrusions.

10. The lighting element of claim 1, wherein the structured refraction surface is designed such that an input light having a first distribution and collimation angle is mapped to an output distribution having a root mean square (RMS) deviation from the prescribed distribution of no more than 1.30 times a minimum value.

11. The lighting element of claim 1, wherein the structured refraction surface is designed such that an input light having a first distribution and collimation angle is mapped to an output distribution having an RMS deviation from the prescribed distribution of no more than 1.25 times a minimum value.

12. The lighting element of claim 1, wherein the structured refraction surface is designed such that an input light having a first distribution and collimation angle is mapped to an output distribution having an RMS deviation from the prescribed distribution of no more than 1.15 times a minimum value.

13. The lighting element of claim 1, wherein the structured refraction surface is designed such that an input light having a first distribution and collimation angle is mapped to an output distribution having an RMS deviation from the prescribed distribution of no more than 1.10 times a minimum value.

14. The lighting element of claim 1, wherein the prescribed distribution of transmitted luminance casts a prescribed distribution of illuminance upon a target surface that is separated from the output end by a distance greater than four times a maximum dimension of the output end.

15. The lighting element of claim 1, wherein the input end comprises a specular reflective surface, a diffuse reflective surface, or a combination thereof.

16-17. (canceled)

18. The lighting element of claim 1, wherein the light collimating horn includes a square cross-section having an input end dimension Wᵢₙₚᵤₜ, an output end dimension Wₒᵤₜₚᵤₜ, and a centerline height H.

19. The lighting element of claim 18, wherein |Wᵢₙₚᵤₜ−Wₒᵤₜₚᵤₜ|/H≦¼.

20. The lighting element of claim 1, wherein the redistribution plate comprises an anti-reflective coating on at least one of the structured refraction surface or an opposing major surface.

21. A luminaire, comprising:
an array of lighting elements, each lighting element comprising:
a light collimating horn having an input end, an output end, and horn sidewalls connecting the input end to the output end;
a light source having an emitting surface disposed within the input end; and
a redistribution plate disposed adjacent the output end of the light collimating horn, the redistribution plate having a structured refraction surface facing the input end,
wherein the redistribution plate is capable of reshaping a partially-collimated angular distribution of incident luminance from the light source to match a prescribed angular distribution of transmitted luminance.

22-60. (canceled)

61. A luminaire, comprising:
an array of lighting elements, each lighting element comprising:
a light collimating horn having an input end, an output end, horn sidewalls connecting the input end to the output end, and a pointing direction from the input end to the output end;
a light source having an emitting surface disposed within the input end; and
a redistribution plate disposed adjacent the output end of the light collimating horn, the redistribution plate having a structured refraction surface facing the input end,
wherein each of the array of lighting elements is disposed adjacent a light pole top end extending from a target surface, the pointing directions collectively arranged in a pyramid shape directed toward the target surface, and
wherein the redistribution plate is capable of reshaping a partially-collimated angular distribution of incident luminance from the light source to match a prescribed angular distribution of transmitted luminance.

62-65. (canceled)
